(19) United States
(12) Patent Application Publication
(10) Pub. No.: US 2022/0388600 A1
(43) Pub. Date: Dec. 8, 2022

(54) PARTIALLY INTEGRATED BATTERY AND ASSOCIATED ELECTRIC BICYCLES

(71) Applicant: Rad Power Bikes Inc., Seattle, WA (US)

(72) Inventors: Joe GRAY, Seattle, WA (US); Derek GUTHEIL, Seattle, WA (US); Erik KLOSIEWSKI, Seattle, WA (US); Bryan FORD, Seattle, WA (US); Jake SILSBY, Seattle, WA (US)

(21) Appl. No.: 17/832,063

(22) Filed: Jun. 3, 2022

Related U.S. Application Data
(60) Provisional application No. 63/196,844, filed on Jun. 4, 2021.

(51) Int. Cl. B62M 6/90; B62M 6/40; B62K 19/40; B62K 19/06; B62J 43/13

(52) U.S. Cl. CPC B62M 6/90; B62M 6/40; B62K 19/40; B62K 19/06; B62J 43/13

(57) ABSTRACT

Electric bicycles having partially integrated batteries, as well as down tubes that accommodate such batteries, controllers, and other components, are described. Further, controller mount components and wiring harnesses are also described. Thus, in some embodiments, an electric bicycle includes various devices or components that facilitate easy and efficient mounting of electrical components (e.g., batteries, controllers, cables and/or wires, and so on) to or within frame components of the electric bicycle.

### CROSS REFERENCE TO RELATED APPLICATIONS

This application claims priority to U.S. Provisional Patent Application No. 63/196,844, filed on Jun. 4, 2021, entitled PARTIALLY INTEGRATED BATTERY AND ASSOCIATED ELECTRIC BICYCLES, which is hereby incorporated by reference in its entirety.

### BACKGROUND

Electric bicycles, or e-bikes, are a popular method of transportation for use by individual riders, families, commercial enterprises and fleets, and so on. Unlike traditional bikes, an e-bike provides assisted modes of travel to a rider, including a peddle assist mode that utilizes power from a motor to assist the rider in pedaling and/or a throttle mode where the motor, when engaged, powers the e-bike without any pedaling from the rider.

Electric bicycles are powered by electric batteries, such as one or more battery packs of multiple battery cells. Conventional battery packs align the cells in series and/or parallel, often positioned right next to one another within a chassis of the battery pack. Typically, the battery pack is mounted externally to a frame component of a bicycle, and/or integrated into the frame of a bicycle.

### BRIEF DESCRIPTION OF THE DRAWINGS

Embodiments of the present technology will be described and explained through the use of the accompanying drawings.

FIG. 1 is a diagram illustrating an electric bicycle having a partially integrated battery.

FIG. 2 is a diagram illustrating a partially integrated battery disposed within a down tube of an electric bicycle.

FIGS. 3A-3C are diagrams illustrating internal configurations of a down tube or other tube of an electric bicycle.

FIGS. 4A-4C are diagrams illustrating aspects of a partially integrated battery.

FIGS. 5A-5C are diagrams illustrating a mounting component for a controller of an electric bicycle.

FIGS. 6A-6B are diagrams illustrating routing of cables within a down tube of an electric bicycle.

FIG. 7 is a diagram illustrating a frame of an electric bicycle and routing of cables along a lower area of the frame.

FIG. 8 is a diagram illustrating a wiring harness for an electric bicycle.

In the drawings, some components are not drawn to scale, and some components can be combined for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Electric bicycles having partially integrated batteries, as well as down tubes that accommodate such batteries, are described. Further, controller mount components and wiring harnesses are also described. Thus, in some embodiments, an electric bicycle includes various devices or components that facilitate easy and efficient mounting of electrical components (e.g., batteries, controllers, cables and/or wires, and so on) to or within frame components of the bicycle, among other benefits.

For example, an electric bicycle can include an electric battery, where the electric battery includes multiple battery cells and a housing that contains the multiple battery cells The housing can have lower portion and an upper portion, where the lower portion of the housing of the electric battery is disposed within an inner area of a down tube of a frame of the bicycle when the electric battery is removably fixed to the frame, and where the upper portion of the housing of the electric battery is disposed outside of the down tube of the frame when the electric battery is removably fixed to the frame. In some cases, the housing includes an edge or portion that acts as a handle or grip to facilitate lifting the battery out of the frame (or placing the battery into the frame).

As another example, a battery for an electric bicycle can include multiple battery cells, a housing that contains the multiple battery cells in vertical positions, including a lower portion having a shape that fits within an inner area of a tube of a frame of an electric bicycle and an upper portion having a shape that facilitates lifting of the battery out of the tube of the frame of the electric bicycle.

As another example, a controller assembly for use with an electric bicycle can include a controller and a mounting component that supports the controller and includes a mounting portion that attaches to an inner area of a tube of an electric bicycle. The controller assembly can include a controller contact area at which the controller is attached to the mounting component, where the controller contact area is smaller in area than an area of the mounting portion that contacts a ledge within the inner area of the tube of the electric bicycle. The mounting component can be formed of a heat transfer material that sinks heat from the controller to the inner area of the tube of the electric bicycle.

While the various technologies are described with respect to, or for use by, an electric bicycle, the technologies can be configured or utilized with other bicycles or cycles, electric scooters or other wheeled micro-mobility vehicles, mopeds, other electric vehicles, and so on.

Various embodiments of the technology will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of Electric Bicycles Having Partially Integrated Batteries

As described herein, in some embodiments, an electric bicycle includes or is powered by a partially integrated battery, such as a battery mounted partially within a down tube of the electric bicycle.

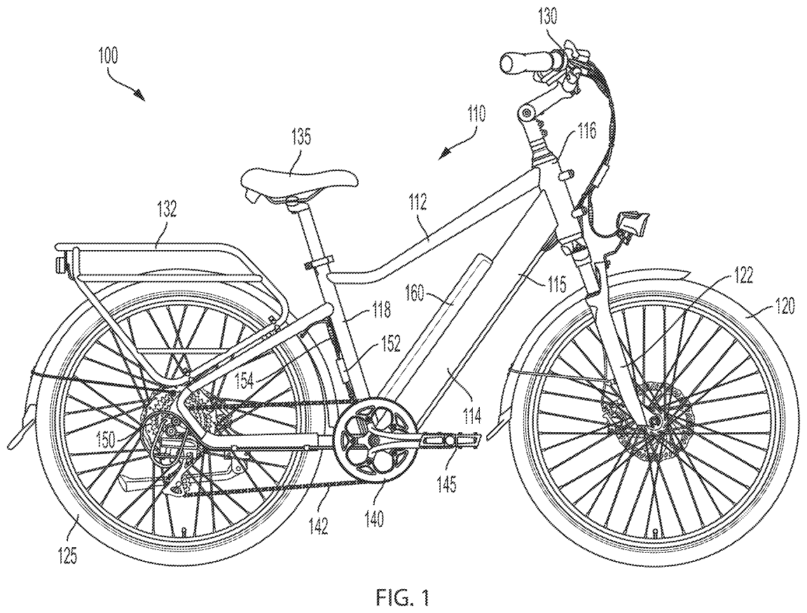

FIG. 1 depicts an off-road style electric bicycle 100 having a partially integrated battery or battery pack 160. The off-road electric bicycle 100 has a high-step frame geometry, such as a frame 110 with a top tube 112 that forms a triangle with a down tube 114 and a seat tube 118.

The electric bicycle 100 further includes a head tube 116 that incorporates a front fork 122 and handlebars 130. The top tube 112 connects the head tube 116 to the seat tube 118, which is substantially parallel to the head tube 116. The down tube 114 also connects the head tube 116 to the seat tube 118 at a bottom portion of the seat tube 118. A seat 135 and seat post 133 is positioned partially in the seat tube 118 and extends or protrudes outwardly from the seat tube 118. The seat post 133 supports the seat 135 (or saddle), upon which a rider sits on the bicycle 100.

The electric bicycle 100 also includes various other components, such as a front wheel 120 and rear wheel 125 that support the frame 110 of the electric bicycle 100, a crankset 140 that supports pedals 145, a chain 142 that extends from the crankset 140 to a rear axle of the rear wheel 125, and a rear rack 132 that supports cargo, passengers (and other accessories).

As depicted, the battery 160 is positioned and/or mounted to the down tube 114, where a controller (not shown) is internally mounted or disposed. Further, an electric motor 150 (e.g., a hub motor) is mounted to the rear wheel 125 (although in some cases could be a mid-drive motor). During operation of the electric bicycle 100, the battery pack 160 provides power to the electric motor 150, which propels the electric bicycle under control of the controller.

A wiring harness 152 can facilitate the securement of cables 154 between components of the electric bicycle 100. For example, the wiring harness 154, described in detail herein, can have a shape that conforms to the shape of the frame 110, such as the shape of the seat tube), in order to facilitate positioning of the harness next to and aligned with the frame 110, in order to securely contain cables that extend along one or more of the tubes between the electrical components.

In addition to the components depicted in FIG. 1, the electric bicycle 100 can include other components, such as brakes and braking systems, various accessories, fenders, various types of rims, tires, or wheels, integrated locks or locking systems, lights and reflectors, bells or other audible alert systems, GPS, screens, and/or other user interfaces or display devices, and so on.

As described herein, the electric bicycle 100 includes the partially integrated battery 160, which is positioned and/or disposed partially within the down tube 114 of the bicycle 100. In other configurations, the battery 160 can be positioned and disposed partially within other tubes of the frame 110 of the electric bicycle 100, such as the top tube 112, the seat tube 118, and so on.

Of course, other bicycles, such as bicycles having different frame geometries or tube configurations can include the partially integrated battery described herein. For example, cargo bikes, single or fixed gear bikes, commuter bikes, mountain bikes, racing bikes, hybrid bikes, and other electric bicycles can include the partially integrated battery 160.

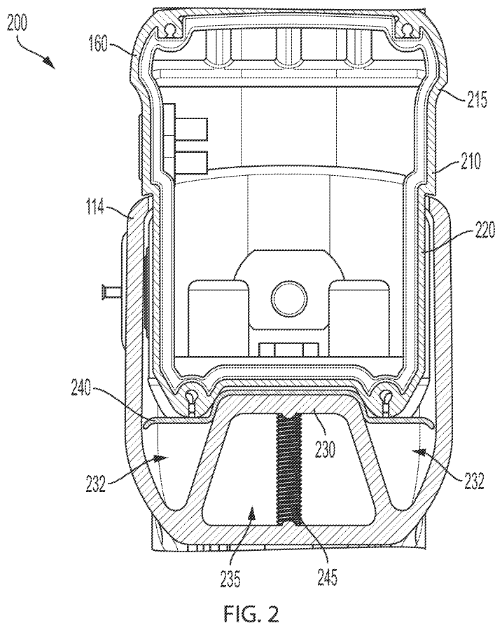

As described herein, the down tube 114 of the frame 110 of the electric bicycle 100 is configured to receive, hold, and/or mount the partially integrated battery 160. FIG. 2 is a diagram 200 illustrating the partially integrated battery 160 disposed (partially) within the down tube 114 of the electric bicycle 100.

As depicted, the battery 160 includes a housing having an upper portion 210 and a lower portion 220. The upper portion 210 is disposed outside of the down tube 114 of the frame when the electric battery is removably fixed to the frame (e.g., placed within the frame during use or operation of a bicycle). The lower portion 220 is disposed within an inner area of the down tube 114 when the electric battery is removably fixed to the frame. The lower portion 220 has a shape or width that fits the inner area of the down tube 114, such that the battery 160 can be placed within the down tube 114 (and removed) by a rider of the bicycle, such as the electric bicycle 100.

The down tube 114, in some embodiments, includes a ledge 230 that supports the lower portion 220 of the battery 160, when the battery 160 is placed or disposed into the down tube 114. The ledge 230 can form an internal cavity 235 as well as side areas or cavities 232, which can be configured to contain cables or wires that extend within the down tube 114. Further, a metal plate 240 or lid can be placed onto the ledge 310 in order to protect the cables within the side areas 232. The battery, in some cases, can be secured to the ledge 230 via a screw or bolt 245.

Thus, when positioned within the down tube 114, the upper portion 210 of the battery 160 is exposed (is external to the down tube 114), while the lower portion 220 is hidden and located within the inner area of the down tube 114. Further, to facilitate the placement of the battery 160 in the down tube 114, the upper portion 210 can include a T-shaped edge 215, such as an edge that facilitates the user gripping the battery 160 to lift the battery out of the down tube 114 and/or gripping the battery to push or otherwise place the battery 160 into the down tube 114.

Thus, the housing can include an edge or portion that acts as a handle or grip to facilitate lifting the battery out of the frame (or placing the battery into the frame). The housing of the battery 160, therefore, has a shape or geometry that facilitates easy placement/removal of the battery 160 from the down tube 114, among other benefits.

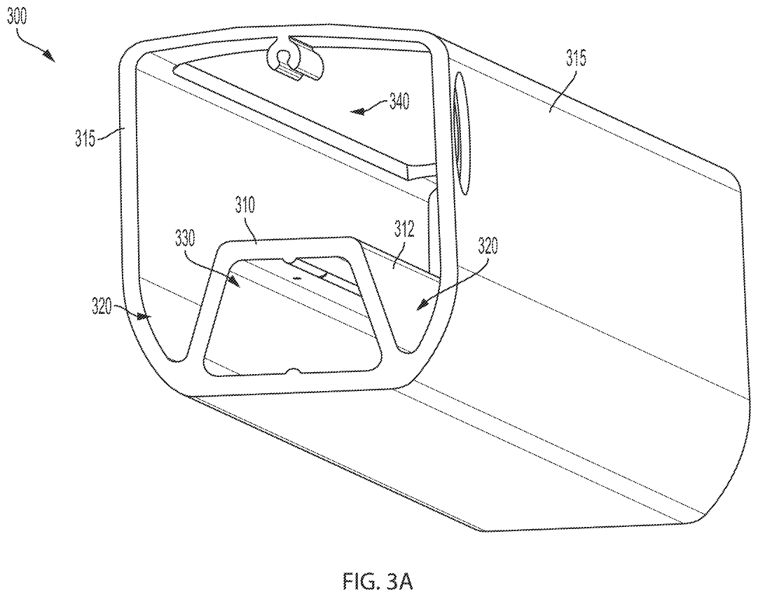

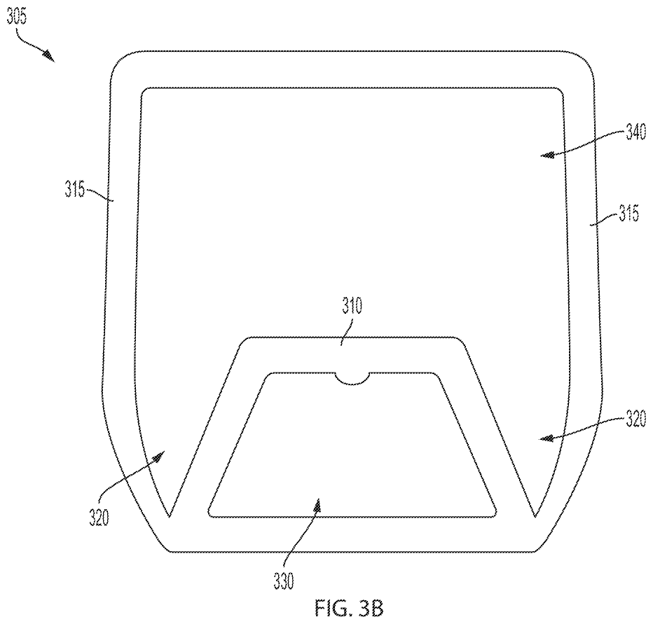

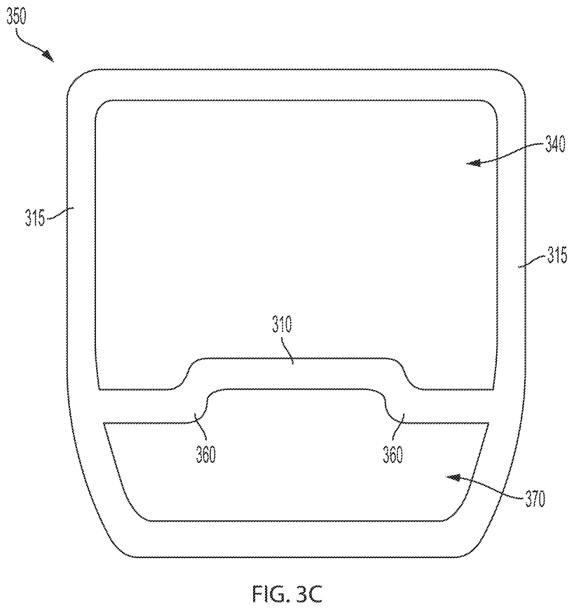

FIG. 3A is a diagram illustrating an internal configuration of a down tube 300 of an electric bicycle. The down tube 300 includes a ledge 310 that forms part of or encloses an internal cavity 330. The ledge 310 is positioned at a height to receive and support a bottom portion of a battery pack when the battery pack is mounted or otherwise disposed within the down tube 300. Thus, an opening 340 or inner area to hold or house the battery pack is formed by the ledge 310 and side walls 315 of the down tube 300.

Next to the internal cavity 330 are side areas or edge areas 320, which facilitate the placement of cables, such as cables that run through the down tube 300 from a controller, past the battery, and to a motor, such as a hub motor, that powers a rear or back wheel of an electric bicycle. Further, the cables can be disposed within the internal cavity 330 and can also run through (or partially through) the down tube 300 from one bicycle component to another.

The down tube 300 can include different internal configurations, in order to facilitate the placement of cables, to provide structural support or integrity, and/or to accommodate or support different components being placed inside, such as the battery 160 and/or a controller.

For example, FIG. 3B depicts a cross-sectional view 305 of the down tube 300 that includes the ledge 310 and side areas 320 that facilitate the placement or containment of cables within the down tube 300. Further, the ledge 310 (which can include supports) forms an internal cavity 330, which can also include cables or wires, such as cables or wires that are inserted into the down tube 300 and protected by the ledge 310.

FIG. 3C depicts a cross-sectional view 350 of the down tube 300 that includes support arms 360, which attach to the side walls 315 of the down tube 300. The support arms 360 position or support the ledge 310 within the inner area of the down tube 300. In some cases, a single piece extends between the side walls 315 (and extends along the down tube 300) to support the structure of the housing of the down tube 300 and provide the ledge 310 to support a battery. The single piece construction (e.g., the ledge 310 and support arms 360) can form an internal cavity 370 configured to contain cables, wires, and so on.

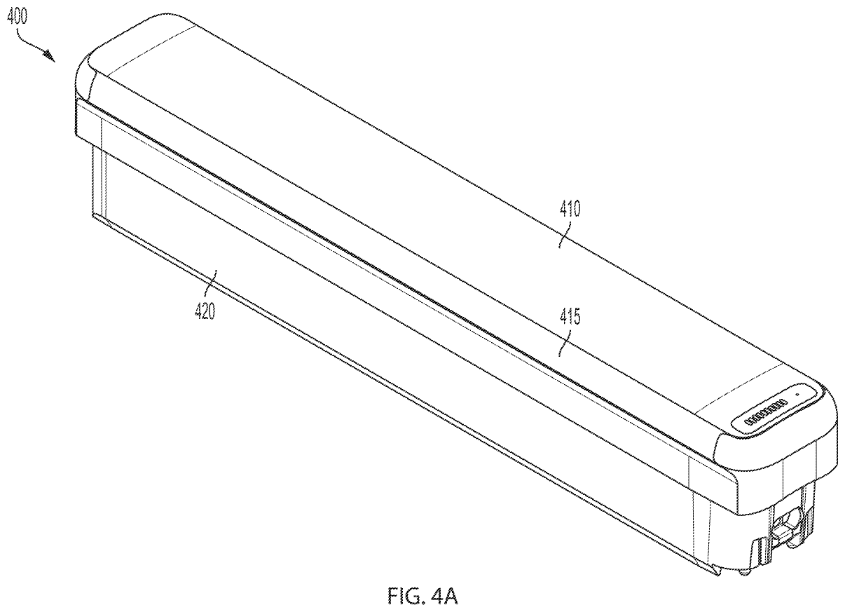

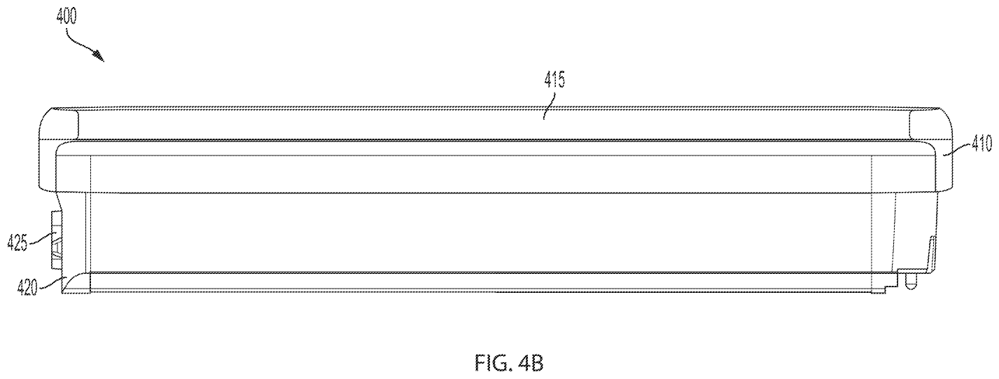

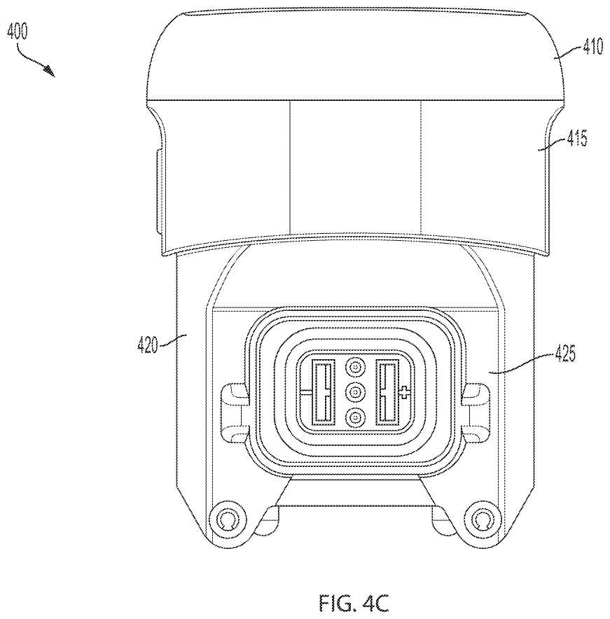

FIGS. 4A-4C are diagrams illustrating a partially integrated battery 400. The partially integrated battery 400, in some embodiments, is a battery pack configured to house or contain multiple battery cells in a vertically spaced configuration. For example, the battery 400 can have a housing shaped to house or contain battery cells in a vertical or upright position. The housing can be a full extruded single member formed of aluminum, and have a shape adapted to fit within the down tube, such as the opening 340 or cavity of the down tube 300 of FIG. 3A. Thus, the battery 400 can support the vertical configuration of cells in an elongated configuration, while also providing a rigid, structurally sound housing for the cells. Further, other embodiments can include the configuration of cells in a horizontal or in-line configuration.

For example, as described herein, the battery 400, when disposed partially within the down tube 300, sits on the ledge 310 of the down tube 300, such that an upper portion 410 of the battery 400 is external or outside of the down tube 300, and a lower portion 420 of the battery 400 is internal or within the down tube 300. In some cases, a width or size of the lower portion of the housing is smaller than a width or size of the upper portion of the housing.

The battery 400 includes various connectors on both a front and/or rear portion of the battery (e.g., end caps). For example, a connector 425 includes various coupling components, sockets, and so on, which facilitate connecting the battery 400, via cables or wires, to other components of an electric bicycle (e.g., the motor, the braking system, and so on). Other connectors can also facilitate the battery 400 connected or coupling to a controller, such as a controller disposed in front of or behind the battery 400 within the down tube 300.

The partially integrated battery 400 has a shape that facilitates easy installation and removal by a user. For example, the upper portion 410 includes a T-shaped edge 415 or gripping area that facilitates a user holding and/or lifting the battery 400 out of the down tube 300. The user can also place the battery within the down tube while gripping the T-shaped edge 415 of the battery 400. In some cases, the battery is placed within the cavity and slid into position, which causes the battery to connect to internal connection components.

The connectors also facilitate the charging of the battery, either within the down tube 300 or outside of the bicycle (e.g., in a user's house or garage). The battery, having a modular assembly, enables the utilization of different connectors, charging or discharging ports, and so on.

Further, the battery 400 can accommodate different types of battery packs. For example, the housing, which is an extruded casing, can receive a battery pack or assembly having multiple cells and a battery management system (BMS). The assembly can facilitate the sliding in of the assembly into the housing of the battery 400, with end caps being attached after the battery pack is contained within the battery 400. The end caps can include the connectors, ports, indicators (e.g., battery level indicators), and so on.

In addition, the battery 400 can include a configuration of cells that are potted after being placed together within a chassis and/or within the pack. The battery pack can include a chassis, multiple battery cells, a potting compound disposed within the chassis and between the cells, and a bus bar or connection material that connects the cells together on a top surface of the chassis. Further details regarding such a configuration can be found in U.S. patent application Ser. No. 17/714,734, filed on Apr. 6, 2022, entitled BATTERY PACKS FOR ELECTRIC BICYCLES, which is hereby incorporated by reference in its entirety.

The connectors 425, in some cases, are blind mate connectors (e.g., blade connectors) that engage connectors within the down tube 300 to facilitate the auto-alignment of the connectors when the battery slides into place within the down tube 300. For example, the connectors restrict movement of the battery 400 as it slides into place to two degrees of freedom, facilitating the coupling of connectors at an angle (e.g., blade connectors into a receiver connector). Once connected, the battery 400 can be locked down into place.

In some cases, the battery 400 can include battery power pins and signal data pins. The battery 400, via the BMS receiving signals via the pins, can detect when it is inserted into the down tube 300 of the bicycle, and change mode of operation (e.g., disable a sleep mode of operation when inserted into the down tube, or enable a sleep mode when removed). Thus, the battery 400 can perform inserting detection operations, and modify the operation of the battery based on a detected use or non-use.

Thus, the partially integrated battery 400 is configured to securely house multiple vertical battery cells in a variety of different assemblies and has a housing that facilitates easy and efficient attachment to a frame of a bicycle (along with connection to internal connectors) and detachment from the frame when not in use or when charged, among other benefits.

Examples of Mounting Controllers within Bicycle Frames

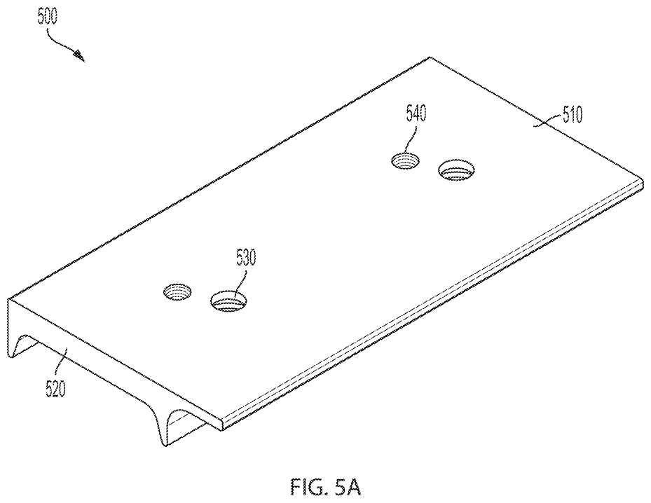

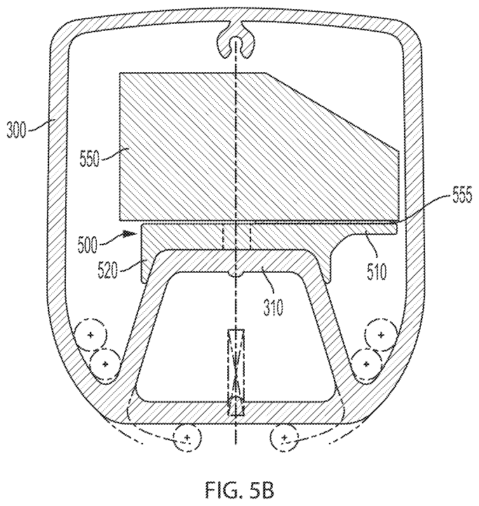

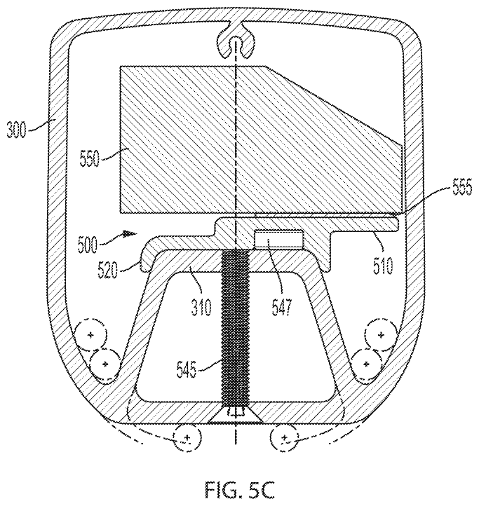

As described herein, in some embodiments, a controller is mounted, fixed, disposed, and/or contained within a frame component of an electric bicycle, such as a down tube (e.g., the down tube 300). FIGS. 5A-5C are diagrams illustrating a mounting component 600 for a controller of an electric bicycle.

As shown in FIG. 5A, a mounting component 500, or controller carrier, facilitates the installation and fixing of a controller (or similar device) to an inside area of a frame component, such as the down tube 300. The mounting component 500 includes a mounting surface 510, which receives and supports a controller, fixing the controller to the mounting component 510.

The mounting component 500 also includes a lower attachment portion 520 having a shape that mates or matches with an internal shape of the down tube 300. For example, the lower attachment portion 520 has a shape (e.g., a chamfer) that fits and partially wraps around the ledge 310 of the down tube 300.

As shown in FIGS. 5B-5C, a controller 550 is fixed to the mounting component 500 via bolts 547 that extend through mounting holes 530 of the component 500, forming a controller assembly. Once fixed, the integrated controller 550 and component 500 can be placed (e.g., slid into place) and fixed within the down tube 300 via bolts 545 that extend through holes 540 aligned with holes at a bottom surface of the down tube 300. Thus, the mounting component 500 can facilitate an easy, secure mounting or fixing of the controller 550 within the down tube 300 (or other frame component), such as in front of or behind a battery also disposed within the down tube 300.

Further, the mounting component 500 can act as an additional or expanded heat sink for the controller 550. Without the mounting component 500, only a small area 555 of the controller 550 may contact the down tube 300 and utilize the down tube 300 to dissipate heat when in use.

However, the controller 550, via the contact area 555, contacts the mounting surface 510 of the carrier 500, which is formed of an aluminum alloy or other similar material that is useful for heat transfer or otherwise dissipates heat. The carrier 510, via the lower attachment portion 520, contacts a larger area of the down tube 300 (e.g., the ledge 310), increasing the surface area that is in contact, and thus increasing the amount of heat that can dissipate from the controller 550 to the down tube 300.

### Examples of Routing Wires for an Electric Bicycle

As described herein, a down tube (e.g., the down tube 300) can have an internal configuration or structure that facilitates the secure and protected placement or running of cables and wires within the tube. Further, the configuration can facilitate the placement of certain cables (e.g., brake or motor cables) at easily accessible or partially external areas, and the placement of other cables (e.g., signal or data cables between components) that are in more secure or internal areas.

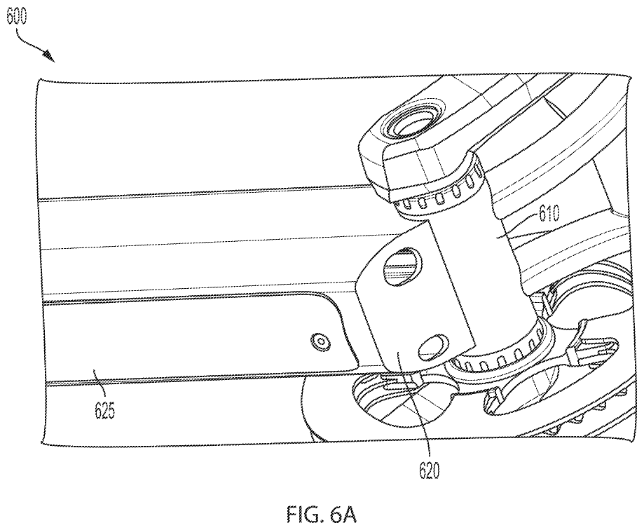

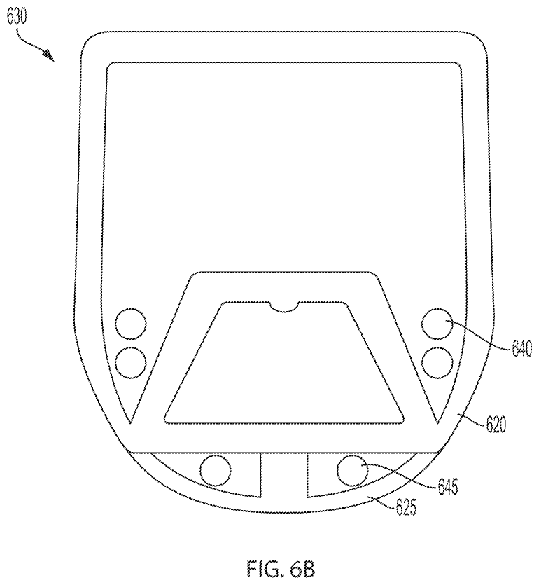

FIGS. 6A-6B depict a down tube 600 having an internal channel 610 and an external channel 620 for routing cables or wires within the tube 600. The external channel 620 can have a detachable cover 625 that protects cables or wires within the channel. Further, the tube can have a cap or other end component that facilitates the insertion of wires or cables into the tube 600, while also allowing the wires or cables to extend out of the tube 600 and to various bike components (brakes, motors, and so on).

For example, the internal channel 610 can contain and/or route wires or conductors 640 for the battery and controller, whereas the external channel 620 can contain and/or route cables 645 for braking, control of the motor, shifting, and so on. Thus, the more accessible cables are cables that are sometimes replaced, whereas the internal cables are cables or conductors routed between electrical components of the bicycle.

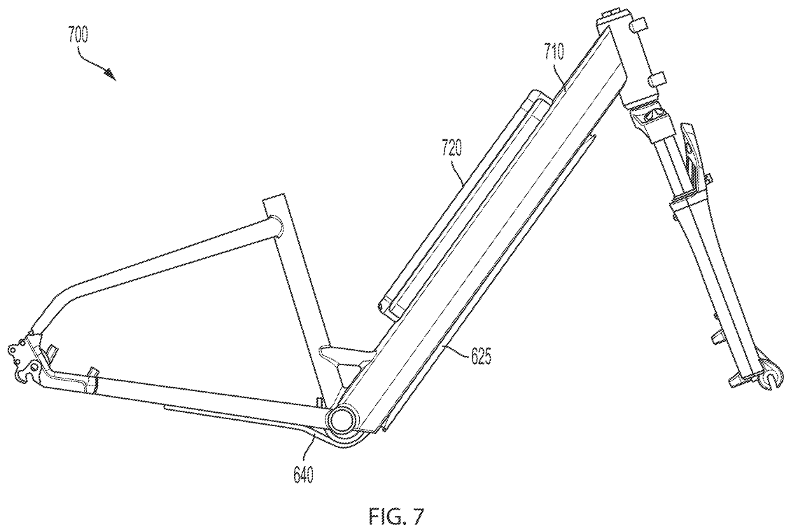

FIG. 7 depicts the routing of cables along a frame 700 of an electric bicycle. The frame 700, which includes a down tube 710 that supports a partially integrated battery 720, includes the detachable cover 625, which provides access to the cables or wires 640 that extend within the down tube 710 from the battery 720, a controller (or handlebars or shifters) to a rear area of the bicycle that includes the motor, brakes, derailleurs, and so on.

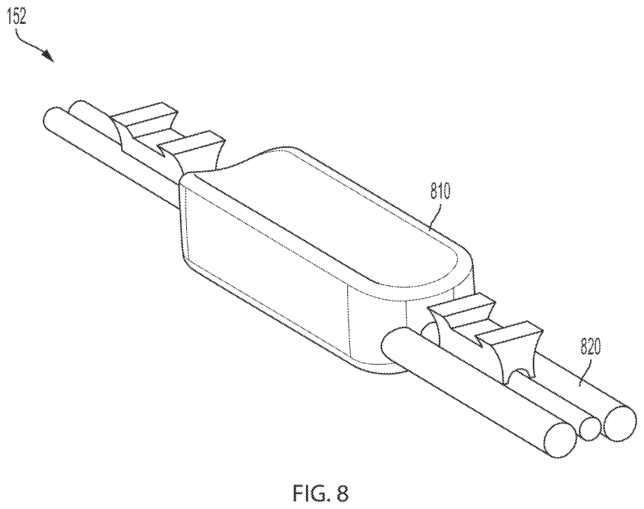

Further, as described herein, the electric bicycle can include a curved wiring harness, such as the harness 152. The harness is configured to manage cables along the frame of the bicycle by conforming to the shape of the frame. FIG. 8 is a diagram illustrating the wiring harness 152 for an electric bicycle. As shown, the wiring harness 152 includes a curved housing 810 or shape, which rests or contacts a curved frame component, such as a down tube, head tube, seat tube, and so on. The harness 152 secures and manages multiple cables 820 at various points, junctions, or locations of the electric bicycle. Thus, the harness can secure and manage the cables 820 along or next to various tubes of the electric bicycle.

### Example Embodiments of the Disclosed Technology

The following are example embodiments of the technology described herein.

In some embodiments, an electric bicycle includes a frame, where the frame includes a head tube configured to support handlebars and a front fork, a seat tube configured to support a saddle post that holds a saddle and is placed at least partially within the seat tube, a top tube that extends from the head tube to the seat tube, and a down tube that extends from the head tube to the seat tube. The electric bicycle also includes an electric battery, where the electric battery includes multiple battery cells and a housing that contains the multiple battery cells and having a lower portion and an upper portion, where the lower portion of the housing of the electric battery is disposed within an inner area of the down tube of the frame when the electric battery is removably fixed to the frame, and where the upper portion of the housing of the electric battery is disposed outside of the down tube of the frame when the electric battery is removably fixed to the frame.

In some cases, the upper portion of the housing of the electric battery includes a handle portion along at least one edge of the housing that facilitates lifting the electric battery out of the down tube of the frame of the electric bicycle.

In some cases, the upper portion of the housing of the electric battery includes a T-shaped edge that facilitates lifting the electric battery out of the down tube of the frame of the electric bicycle.

In some cases, a width of the lower portion of the housing is smaller than a width of the upper portion of the housing.

In some cases, the down tube includes a ledge positioned within the inner area of the down tube upon which the electric battery sits when disposed within the inner area of the down tube of the frame.

In some cases, the down tube includes a ledge that extends from one side of the down tube to an opposite side of the down tube within the inner area of the down tube and is configured to support the electric battery when disposed within the inner area of the down tube of the frame.

In some cases, the down tube includes a ledge that forms an internal cavity within the inner area of the down tube and is configured to support the electric battery when disposed within the inner area of the down tube of the frame.

In some cases, the down tube includes a ledge that forms an internal cavity within the inner area of the down tube and is configured to support the electric battery when disposed within the inner area of the down tube of the frame and edge areas proximate to the internal cavity that are configured to contain one or more cables that are disposed within the inner area of the down tube.

In some cases, the down tube includes a ledge positioned within the inner area of the down tube upon which the electric battery sits when disposed within the inner area of the down tube of the frame, a controller disposed within the inner area of the down tube of the frame and a controller carrier that mounts the controller to the ledge positioned within the inner area of the down tube.

In some cases, the multiple battery cells are positioned in a vertical orientation within the housing of the electric battery.

In some embodiments, a battery for an electric bicycle includes multiple battery cells, a housing that contains the multiple battery cells in vertical positions, including a lower portion having a shape that fits within an inner area of a tube of a frame of an electric bicycle and an upper portion having a shape that facilitates lifting of the battery out of the tube of the frame of the electric bicycle.

In some cases, the upper portion has a T-shaped edge.

In some cases, the lower portion has a tube engagement portion that matches a shape of a ledge within the inner area of the tube of the frame of the electric bicycle when the battery is disposed partially within the tube of the frame of the electric bicycle.

In some cases, the multiple battery cells are part of a cell assembly that is positioned within the housing and includes a potting compound disposed between the multiple battery cells within the cell assembly.

In some cases, the housing includes a battery management system and end caps that include one or more connectors, one or more ports, and one or more indicators.

In some cases, the shape of the lower portion has a geometry that facilitates placement of the battery partially within a down tube of the frame of the electric bicycle.

In some cases, the shape of the lower portion has a geometry that facilitates placement of the battery partially within a top tube of the frame of the electric bicycle.

In some embodiments, a controller assembly for use with an electric bicycle includes a controller and a mounting component that supports the controller and includes a mounting portion that attaches to an inner area of a tube of an electric bicycle.

In some cases, the mounting component includes a controller contact area at which the controller is attached to the mounting component, where the controller contact area is smaller in area than an area of the mounting portion that contacts a ledge within the inner area of the tube of the electric bicycle.

In some cases, the mounting component is formed of a heat transfer material that sinks heat from the controller to the inner area of the tube of the electric bicycle

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. An electric bicycle, comprising:
a frame, wherein the frame includes:
a head tube configured to support handlebars and a front fork;
a seat tube configured to support a saddle post that holds a saddle and is placed at least partially within the seat tube;
a top tube that extends from the head tube to the seat tube; and
a down tube that extends from the head tube to the seat tube; and
an electric battery, wherein the electric battery includes:
multiple battery cells; and
a housing that contains the multiple battery cells and having a lower portion and an upper portion,
wherein the lower portion of the housing of the electric battery is disposed within an inner area of the down tube of the frame when the electric battery is removably fixed to the frame, and
wherein the upper portion of the housing of the electric battery is disposed outside of the down tube of the frame when the electric battery is removably fixed to the frame.

2. The electric bicycle of claim 1, wherein the upper portion of the housing of the electric battery includes a handle portion along at least one edge of the housing that facilitates lifting the electric battery out of the down tube of the frame of the electric bicycle.

3. The electric bicycle of claim 1, wherein the upper portion of the housing of the electric battery includes a T-shaped edge that facilitates lifting the electric battery out of the down tube of the frame of the electric bicycle.

4. The electric bicycle of claim 1, wherein a width of the lower portion of the housing is smaller than a width of the upper portion of the housing.

5. The electric bicycle of claim 1, wherein the down tube includes a ledge positioned within the inner area of the down tube upon which the electric battery sits when disposed within the inner area of the down tube of the frame.

6. The electric bicycle of claim 1, wherein the down tube includes a ledge that extends from one side of the down tube to an opposite side of the down tube within the inner area of the down tube and is configured to support the electric battery when disposed within the inner area of the down tube of the frame.

7. The electric bicycle of claim 1, wherein the down tube includes a ledge that forms an internal cavity within the inner area of the down tube and is configured to support the electric battery when disposed within the inner area of the down tube of the frame.

8. The electric bicycle of claim 1, wherein the down tube includes:
a ledge that forms an internal cavity within the inner area of the down tube and is configured to support the electric battery when disposed within the inner area of the down tube of the frame; and
edge areas proximate to the internal cavity that are configured to contain one or more cables that are disposed within the inner area of the down tube.

9. The electric bicycle of claim 1, wherein the down tube includes a ledge positioned within the inner area of the down tube upon which the electric battery sits when disposed within the inner area of the down tube of the frame, the electric bicycle further comprising:
a controller disposed within the inner area of the down tube of the frame; and
a controller carrier that mounts the controller to the ledge positioned within the inner area of the down tube.

10. The electric bicycle of claim 1, wherein the multiple battery cells are positioned in a vertical orientation within the housing of the electric battery.

11. A battery for an electric bicycle, the battery comprising:
multiple battery cells; and
a housing that contains the multiple battery cells in vertical positions, wherein the housing includes:
a lower portion having a shape that fits within an inner area of a tube of a frame of an electric bicycle; and
an upper portion having a shape that facilitates lifting of the battery out of the tube of the frame of the electric bicycle.

12. The battery of claim 11, wherein the upper portion has a T-shaped edge.

13. The battery of claim 11, wherein the lower portion has a tube engagement portion that matches a shape of a ledge within the inner area of the tube of the frame of the electric bicycle when the battery is disposed partially within the tube of the frame of the electric bicycle.

14. The battery of claim 11, wherein the multiple battery cells are part of a cell assembly that is positioned within the housing and includes a potting compound disposed between the multiple battery cells within the cell assembly.

15. The battery of claim 11, wherein the housing includes:
a battery management system; and
end caps that include one or more connectors, one or more ports, and one or more indicators.

16. The battery of claim 11, wherein the shape of the lower portion has a geometry that facilitates placement of the battery partially within a down tube of the frame of the electric bicycle.

17. The battery of claim 11, wherein the shape of the lower portion has a geometry that facilitates placement of the battery partially within a top tube of the frame of the electric bicycle.

18. A controller assembly for use with an electric bicycle, the controller assembly comprising:
a controller; and
a mounting component that supports the controller and includes a mounting portion that attaches to an inner area of a tube of an electric bicycle.

19. The controller assembly of claim 18, wherein the mounting component includes:
a controller contact area at which the controller is attached to the mounting component,
wherein the controller contact area is smaller in area than an area of the mounting portion that contacts a ledge within the inner area of the tube of the electric bicycle.

20. The controller assembly of claim 18, wherein the mounting component is formed of a heat transfer material that sinks heat from the controller to the inner area of the tube of the electric bicycle.
